(19) United States
(12) Patent Application Publication
(10) Pub. No.: US 2026/0309515 A1
(43) Pub. Date: Oct. 8, 2026

(54) Location Sensing Assembly

(71) Applicant: Sigma Powertrain, Inc., Livonia, MI (US)

(72) Inventor: Jeffrey Viola, Clinton Township, MI (US)

(73) Assignee: Sigma Powertrain, Inc., Livonia, MI (US)

(21) Appl. No.: 19/639,654

(22) Filed: Apr. 6, 2026

Related U.S. Application Data
(60) Provisional application No. 63/783,642, filed on Apr. 4, 2025.

(51) Int. Cl. G01D 5/14; G01D 11/24

(52) U.S. Cl. CPC G01D 5/145; G01D 11/245

(57) ABSTRACT

A location sensing assembly for sensing lateral motion of a conductive targetin an electromagnetic structure that actuates the conductive target. The location sensing assembly is shown having two embodiments. In a first embodiment, the sensing of the lateral movement of the conductive target is done using an inductive sensor. In a second embodiment, the sensing is done using a magnetic sensor. In both instances, the sensors are located in an enclosed environment with large magnetic fields passing therethrough.

This application claims priority to U.S. Provisional Patent Application to Jeffrey Viola entitled “Location Sensing Assembly,” application serial number 63/783,642, filed April 4, 2025, the disclosures of which are hereby expressly incorporated herein by reference.

### BACKGROUND OF THE INVENTION

### 1. Field of the Invention

This invention relates generally to an assembly that senses a location of an element encased in a structure. More particularly, the invention relates to a sensor incorporating magnetic or inductive components to accurately detect the linear movement of a rotating element embedded in a structure.

### 2. Description of the Related Art

There are situations when two devices need to rotate together. Other times, the two devices need to be disconnected from each other to allow them to rotate independently of each other. Selectively coupling these rotating devices together can be difficult. One example of a coupling system is disclosed in US Pat 11,215,245 B2. This system requires solenoids and multiple coupling members. These types of devices are complex with multiple moving pieces. They also are heavy and require clearance to install and operate. It is also difficult to identify where an actuator is within such a device.

### SUMMARY OF THE INVENTION

A location sensing assembly for sensing lateral motion of a conductive targetin an electromagnetic structure creating actuation of the conductive target. The location sensing assembly includes a signal generating circuit to produce an AC wave signal to create an AC electromagnetic field. At least one conductive material used to generate at least one modified AC electromagnetic field. An induced receiving element receives the at least one modified AC electromagnetic field to induce a modified current. A modified current receiver is electrically connected to the signal receiving element to receive the at least one modified AC wave signal. A signal analyzer is electrically connected to the modified current receiver to analyze the at least one received modified AC wave signal to determine a linear location of the conductive target moving laterally within a structural frame securing the conductive target therewithin.

### BRIEF DESCRIPTION OF THE DRAWINGS

A more complete understanding of the technologies disclosed herein may be derived by referring to the detailed description and claims when considered in connection with the Figures, wherein like reference numbers refer to similar items throughout the Figures, and:

FIG. 1 is a cross-sectional side view of a selectively rotating element with an actuator in a first position;

FIG. 2 is an enlarged cross-sectional side view the circle A of FIG. 1;

FIG. 3 is a cross-sectional side view of a selectively rotating element with an actuator in a second position;

FIG. 4 is an enlarged cross-sectional side view the circle B of FIG. 3;

FIG. 5 is a side view of a clutch actuator partially cut away to show a portion of a winding and the location sensing assembly;

FIG. 6 is an enlarged cross-sectional side view of the circle C of FIG. 5;

FIG. 7 is a top view of a circuit board and sensor used in one embodiment of the location sensing assembly;

FIG. 8 is a perspective view of a circuit board and sensors used in a second embodiment of the invention.

### DETAILED DESCRIPTION OF EMBODIMENTS OF THE INVENTION

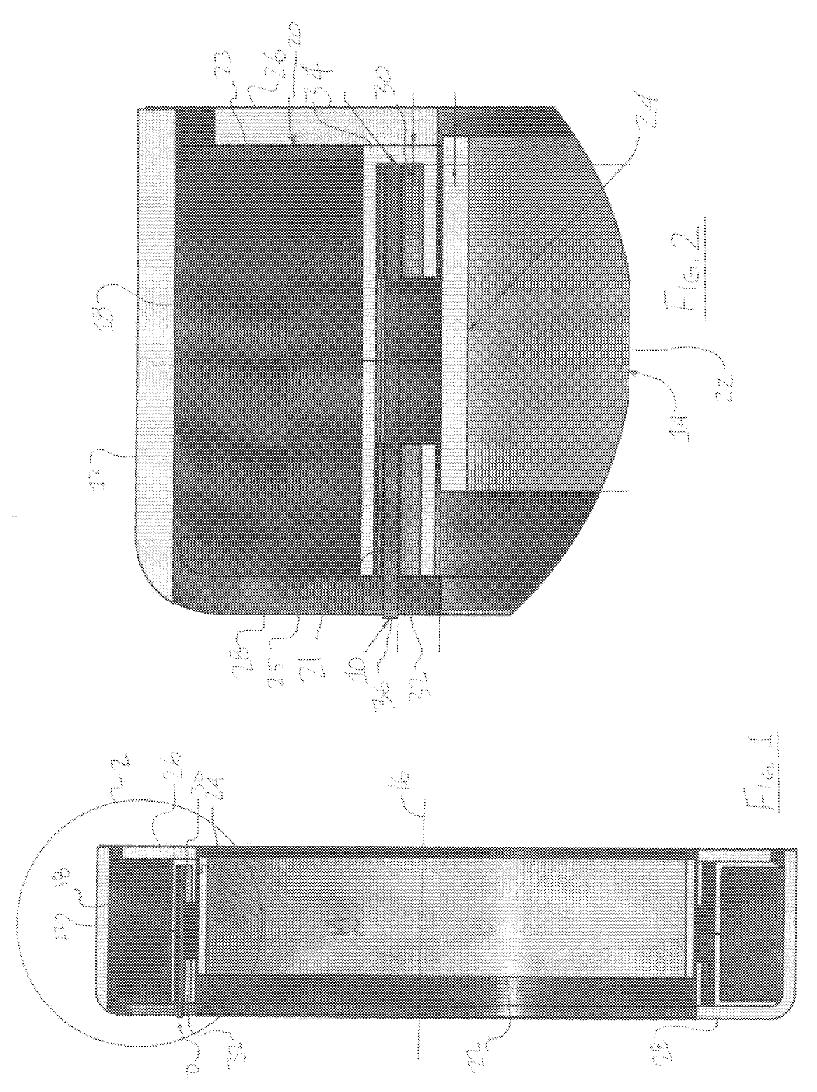

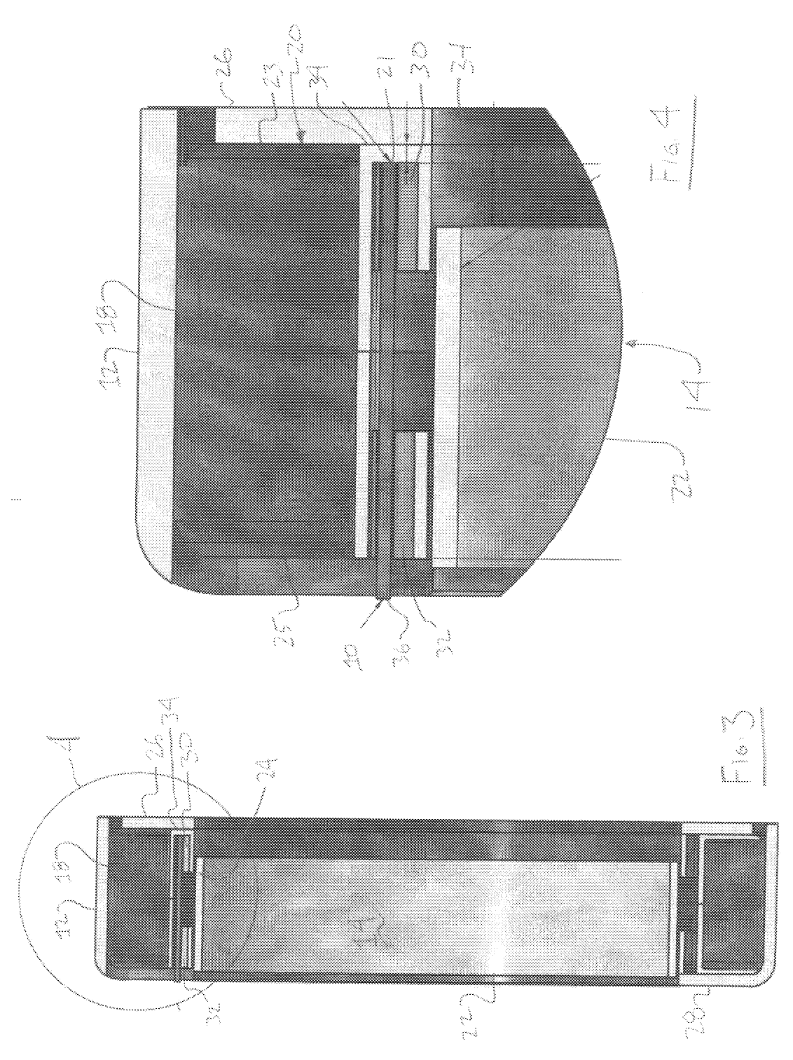

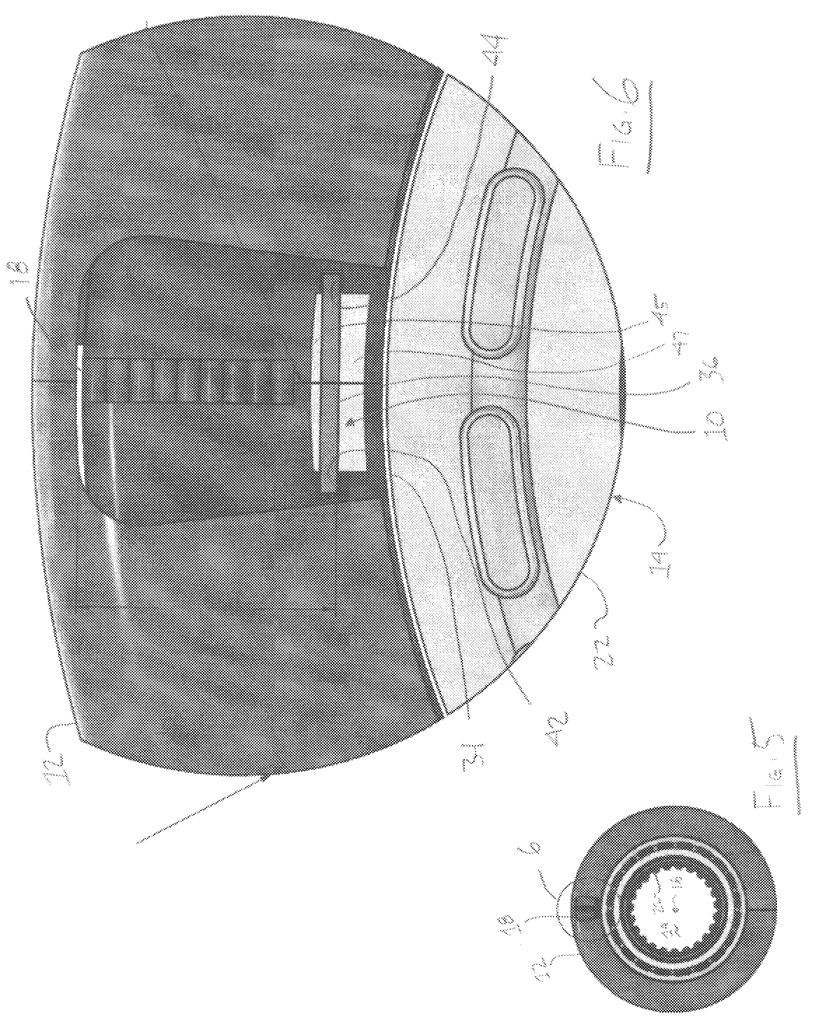

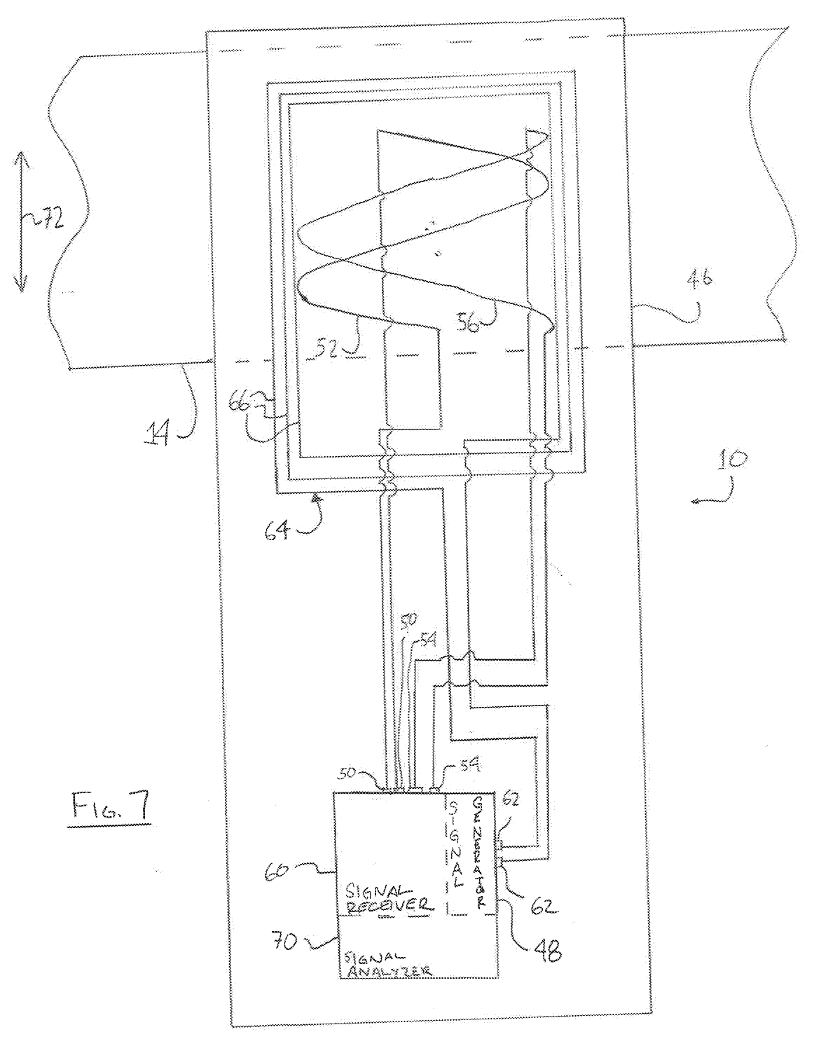

Referring to the Figures, a location sensing assembly is generally shown at 10. The location sensing assembly 10 is built into an electromagnetic structure 12. The electromagnetic structure 12 is fabricated from a hard ferromagnetic material such as steel, and acts as a structural frame. The electromagnetic structure 12 houses a actuating ring, generally indicated at 14, that is free to rotate about a central axis 16 (best seen in FIGS. 1 and 5). In the embodiment shown, the electromagnetic structure 12 is a housing for a wheel disconnect device used to disconnect a driven shaft from a wheel (neither shown). It should be appreciated by those skilled in the art that the driven shaft could also be a drive shaft, depending on where it is designed for the connection and disconnection between these elements is to occur. It should also be contemplated that the electromagnetic structure 12 can be used for any sort of device that has a rotating ring therein.

The electromagnetic structure 12 also includes a coil 18 of ferromagnetic material. Typically, the coil 18 is made of copper. The coil 18 consists of a wire wound about a plastic bobbin 20 that is held in place by the electromagnetic structure 12. The bobbin includes an inner ring 21, a first bobbin side 23, and a second bobbin side 25. In cross section, the three components 21, 23, 25 of the bobbin 20 form a U-shape. When current is sent through the coil 18, a magnetic field is created that is strong enough that it applies a force to the actuating ring 14 that is lateral in direction, i.e., parallel to the central axis 16. The actuating ring 14 is biased in one lateral direction or the other (right or left from the perspective of looking at the FIGS. 3 or 1, respectively). Which direction in which the actuating ring 14 is biased is based on which direction in which the electrical current is flowing through the coil 18.

The actuating ring 14 includes an engaging ring 22 and a ferromagnetic outer ring 24 extending about the periphery of the engaging ring 20. The engaging ring 22 selectively engages or disengages the wheel from the driven shaft. The ferromagnetic outer ring 24 is fixedly secured to the engaging ring 22 such that there is no lost motion therebetween. It is the ferromagnetic ring 24 that is biased in one direction or the other by the magnetic field created by the electric current flowing through the coil 18.

Because the actuating ring 14 can rotate about the central axis 16 at high speeds, it is important to know where the actuating ring 14 is laterally within the electromagnetic structure 12. More specifically, it is important to know whether the actuating ring 14 is disposed adjacent a first side 26 or a second side 28 of the electromagnetic structure 12. However, the actuating ring 14 is sealed within the electromagnetic structure 12 and its lateral or linear position cannot be visually determined. Compounding this issue is the fact that the coil 18 generates a strong magnetic current. Further compounding this issue is the fact that there are two series of permanent magnets 30, 32 that are fixedly secured to the bobbin inner ring 21, each of the two series of permanent magnets 30, 32 are individually secured in pole-to-pole orientation along the bobbin inner ring 21 within a magnet holding ring 34. More specifically, the magnet holding ring 34 includes two channels (not shown) with each of the two channels holding one of the two series of permanent magnets 30, 32. The channels include a plurality of partitions to separate each of the two series of permanent magnets 30, 32 from each other. The magnetic fields created by the two series of permanent magnets 30, 32 are used to latch (hold) the actuating ring 14 in an engaged state or a disengage state such that the actuating ring 14 will maintain its state regardless of the presence or absence of power. These magnetic fields are equal in magnitude, but the poles are opposite. A more complete description of this configuration can be seen by co-owned United States Patent 11,828,335, the disclosure of which is expressly incorporated herein by reference. The first series of magnets 30 extends along the bobbin inner ring 21 adjacent the first side 26 of the electromagnetic structure 12 and the second series of magnets 32 extends along the bobbin inner ring 21 adjacent the second side 28 of the electromagnetic structure.

The location sensing assembly 10 determines the linear location of the actuating ring 14, whether it is rotating or not, within the electromagnetic structure 12 that secures the actuating ring 14 therein. The location sensing assembly 10 does not measure the rotational orientation of the actuating ring 14, but only where it is laterally within the electromagnetic structure 12. The actuating ring 14, particularly the ferromagnetic outer ring 22, is a conductive target. Knowing where the conductive target 14 is laterally identifies when the wheel is connected to the driven shaft and when those two automotive components are disconnected. By using the ferromagnetic outer ring 22 as the conductive target eliminates the need for a second or separate target. This reduces inventory and the task of assembling a device with more components.

Referring to FIG. 6, the location sensing assembly 10 includes a housing 36. The housing 36 is fabricated from a non-ferromagnetic material to allow electromagnetic fields to pass therethrough. In the embodiment shown in the FIG. 6, the housing 36 is rectangular in shape. The housing 36 is longer than the distance between two partitions 38, 40 in the two channels below the bobbin inner ring 21. For these two partitions, slots 42, 44 are formed therein to receive two of the ends of the housing 36. Spaces 45, 47 above and below the housing 36 remain void of a permanent magnet 30, 32. These spaces 45, 47 are air gaps. It is contemplated that there will be multiple location sensing assemblies 10 spaced equidistantly about the electromagnetic structure 12 interspersed amongst the two sets of permanent magnets 30, 32. It is also contemplated that no two location sensing assemblies 10 will be configured in end-to-end configuration and that there will be at least one of the two sets of permanent magnets 30, 32 in between the location sensing assemblies 10.

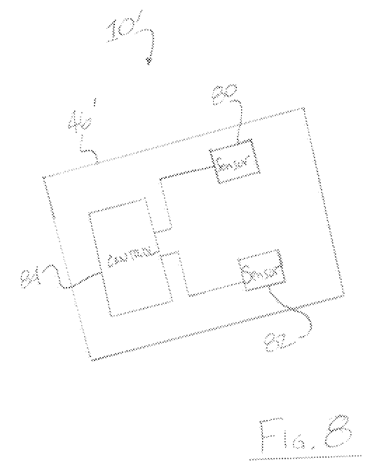

Referring to FIG. 7, a first embodiment of the location sensing assembly 10 is schematically shown. The location sensing assembly 10 includes a printed circuit board 46 mounted within the housing 36. In this schematic representation, the printed circuit board 46 is perpendicular to the length of the housing 36.

The location sensing assembly 10 includes a signal generating circuit 48 to produce an alternating current (AC) signal. The AC signal may be a sine wave signal, a cosine wave signal, or some other signal that alternates. The AC signal is transmitted through an output port 62 to a first magnetic signal generating circuit 64. In the embodiment shown, the first magnetic signal generating circuit 64 includes three loops 66 extending thereabout. The AC current in the first magnetic signal generating circuit 64 generates a signal magnetic field. is a sinusoidally-shaped conductive wire. A second AC signal is transmitted through a second set of ports 54 to a second magnetic signal generating circuit 56. The second magnetic signal generating circuit 56 is also a sinusoidally-shaped conductive wire whose path is offset from the first magnetic signal generating circuit 52.

The location sensing assembly 10 also includes a signal receiver 60. The signal receiver 60 includes a first 50 and second 54 sets of receiver ports. Electrically connected to the set of receiver ports 62 are two induction receiving circuit 52, 56. The induction receiving circuits 52, 56 are sinusoidally shaped conductive wires with the second induction receiving circuit 56 being is linearly offset from the first induction receiving circuit 52. The induction receiving circuits 52, 56 generate induced currents when it senses the signal magnetic field created by the magnetic signal generating circuit 64. That induced currents are received by the signal receiver 60.

The signal receiver 60 transmits the induced current received to a signal analyzer 70. The signal analyzer 70 analyzes the induced current. Because the current generated in the induction receiving circuit 64 is induced, the current changes when the actuating ring 14 (schematically represented as being beneath the location sensing assembly 10 in FIG. 7) moves bidirectionally relative to the location sensing assembly 10 as represented by arrow 72. More specifically, the presence or absence of the actuating ring 14 will affect the induced current being created in the induction receiving circuit 64 to indicated whether the actuating ring 14 is located directly under the first 52 and second 56 magnetic signal generating circuits and the induction receiving circuit 64. In one embodiment, the signal generator 48, the signal receiver 60 and the signal analyzer 70 are all packaged together in a single integrated circuit chip. One example of such an integrated circuit chip is the AMS AS5715R inductive motor control position sensor produced by ams-OSRAM AG, of Premstaetten, Austria.

Even though the passive, latching magnetic fields created by the two sets of permanent magnets 30, 32 are present, and the magnetic field created by the coil 18 may be present, the signal receiver 60 is able to sense the differences in the induced current created in the induction receiving circuit 64 to identify the lateral position of the actuating ring 14 relative to the location sensing assembly 10.

Referring to FIG. 8, wherein elements similar to those discussed above are represented by primed reference numerals, a second embodiment of the location sensing assembly 10’ is shown. In this embodiment, the sensing of the lateral position of the actuating ring 14 incorporates the use of a first 80 and second 82 Hall Effect sensors. The Hall Effect sensors 80, 82 identify the lateral position of the actuating ring 14 by sensing the changes to the magnetic fields found within the electromagnetic structure 12. Unlike the first embodiment of the location sensing assembly 10, the second embodiment 10’ utilizes the DC biased magnetic field from the two sets of permanent magnets 30, 32. The DC biased magnetic field is modified by the presence or absence of the actuating ring 14 as it moves laterally with respect to the location sensing assembly 10’. This modified magnetic field is measured by at least one of the Hall Effect sensors 80, 82. A control 84 receives the signals and analyzes the output of the two Hall Effect sensors 80, 82 to identify the lateral position of the actuating ring 14. Because the latching magnetic fields created by the two sets of permanent magnets 30, 32 are constant, equal and opposite, subtracting the outputs of the Hall Effect sensors 80, 82 serves to mathematically allow for uniform field cancellation of the applied actuator magnetic field, allowing motion measurement of the conductive element even while the actuation magnetic field is applied. It should be appreciated by those skilled in the art that the while the control 84 is shown mounted within the location sensing assembly 10’, it may be further down the electronics path and not incorporated into the location sensing assembly 10’.

The embodiments and examples set forth herein were presented to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed.

Many modifications and variations are possible in light of the teachings above without departing from the spirit and scope of the forthcoming claims.

I claim:

1. A location sensing assembly for sensing lateral motion of a conductive targetin an electromagnetic structure creating actuation of the conductive target, said location sensing assembly comprising:
a signal generating circuit to produce an AC wave signal to create an AC electromagnetic field;
an induced receiving circuit to receive the at least one modified AC electromagnetic field to induce a modified current;
a signal receiver electrically connected to said induced receiving circuit to receive the modified current; and
a signal analyzer electrically connected to said signal receiver to analyze the modified current to determine a linear location of the conductive target moving laterally within a structural frame securing the conductive target therewithin.

2. A location sensing assembly as set forth in claim 1 wherein said induced receiving circuit includes a first arcuate portion.

3. A location sensing assembly as set forth in claim 2 including a second induced receiving circuit used to generate a second modified current.

4. A location sensing assembly as set forth in claim 3 wherein said second induced receiving circuit includes a second arcuate portion offset from said first arcuate portion.

5. A location sensing assembly as set forth in claim 4 wherein said induced receiving circuit extends within said signal generating circuit.

6. A location sensing assembly as set forth in claim 5 wherein said signal generating circuit defines a loop.

7. A location sensing assembly as set forth in claim 5 wherein said signal generating circuit defines a plurality of loops.

8. A location sensing assembly as set forth in claim 7 wherein said multiple loops are coaxial.

9. A location sensing assembly as set forth in claim 7 wherein said multiple loops are coplanar.

10. A location sensing assembly for sensing lateral position of a conductive target relative to an electromagnetic structure having a coil of conductive wire wound therein defining an inner coil diameter, a first side, and a second side, said location sensing assembly comprising:
a first Hall Effect sensor disposed adjacent the first side of the coil for generating a first signal; and
a second Hall Effect sensor disposed adjacent the second side of the coil for generating a second signal; and
a control electrically connected to said first and second Hall Effect sensors to receive the first and second signals to compare them to identify the lateral position of the conductive target, such that each of said first and second Hall Effect sensors sense a change in the magnetic field when the conductive target moves with respect thereto.

11. A location sensing assembly as set forth in claim 10 including a sensor housing to house said first and second Hall Effect sensors in spaced relation.

12. A location sensing assembly as set forth in claim 11 wherein said first and second Hall Effect sensors are coplanar.
